(19) United States
(12) Patent Application Publication
(10) Pub. No.: US 2008/0270561 A1
(43) Pub. Date: Oct. 30, 2008

(54) System and Method of Recommendation and Provisioning of Mobile Device Related Content and Applications

(75) Inventors: Thomas Cheuk Kai Tang, Markham (CA); John Patrick Mah, Thornhill (CA); Sean Edward Maurik, Thornhill (CA)

Correspondence Address: BAKER & DANIELS LLP;111 E. WAYNE STREET, SUITE 800, FORT WAYNE, IN, 46802, US

(73) Assignee: CASCADA MOBILE CORP., Toronto, Ontario (CA)

(21) Appl. No.: 11/994,061

(22) PCT Filed: Jun. 30, 2006
(86) PCT No.: PCT/CA06/01085

§ 371 Date: May 21, 2008

Related U.S. Application Data
(60) Provisional application No. 60/695,739, filed on Jun. 30, 2005.

(51) Int. Cl. G06F 15/16

(52) U.S. Cl. 709/207

(57) ABSTRACT

A recommendation system for mobile device content comprising: a recommendation server enabled to communicate with a wireless mobile device of a recipient user, the server being configured for receiving from a recommendation source a recommendation request message including information identifying recommended content and a recipient user, determining based on predetermined criteria if a recommendation is permitted and if so, causing a recipient recommendation message including information identifying the recommended content to be sent to the recipient user's mobile device.

This application claims priority to and incorporates by reference U.S. Provisional Patent Application No. 60/695,739, filed Jun. 30, 2005.

### FIELD

Embodiments of the invention relates to a system and method of distribution of mobile device content and applications. In particular, example embodiments of the invention relate to a system and method of peer to peer recommendation and provisioning of mobile device content and applications.

### BACKGROUND

Mobile carriers have spent significant effort on creating advanced wireless data services for mobile devices, and encouraging their clients to use such advanced wireless data services. Despite these efforts, a substantial number of mobile carrier customers do not use these services. It would be desirable to increase the number of mobile carriers who use such services through increased distribution of same.

Marketers and their agencies are also looking to branded applications on mobile devices as another channel for communication with their customers. Most of them would like to be able to extend those campaigns through the peer to peer dissemination of those applications.

Due to variances in mobile devices, the simple transference of content from one device to another is not a viable solution.

There is a need for an improved system and method for distribution of mobile content and applications in mobile devices.

### SUMMARY

According to one example embodiment described herein is a recommendation system for mobile device content comprising: a recommendation server enabled to communicate with a wireless mobile device of a recipient user, the server being configured for receiving from a recommendation source a recommendation request message including information identifying recommended content and a recipient user, determining based on predetermined criteria if a recommendation is permitted and if so, causing a recipient recommendation message including information identifying the recommended content to be sent to the recipient user's mobile device.

According to another example embodiment described herein is a method for facilitating recommendation of content from a mobile device of a recommendation sender to a mobile device of a recipient user, comprising the following steps: (a) receiving at a recommendation server a recommendation request message requesting that selected content be recommended to a recipient mobile device that is identified in the recommendation request message; (b) causing a recipient recommendation message to be sent to the recipient mobile device that includes address information for directing a browser on the recipient mobile device to the recommendation server; (c) receiving at the recommendation server from the recipient mobile device information about the recipient mobile device and in dependence thereon identifying at least one host location that the recipient mobile device can access to obtain the selected content; (d) receiving an acceptance from the recipient mobile device indicating that the recipient user desires to obtain the selected content and directing the recipient mobile device to a host location to obtain the selected content.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

Embodiments of the invention will be described with reference to the accompanying drawings, wherein:

FIG. 1 is schematic representation of an overview of an embodiment of the system of the invention.

FIG. 2 illustrates the message flow and process from recommendation to download of the recommended content.

FIG. 3 shows sample user interface screens for a recommendation sender's mobile device.

FIG. 4 shows sample user interface screens for a recipient's mobile device.

### DESCRIPTION OF EXAMPLE EMBODIMENTS

A glossary of terms is provided to set out the meaning of certain terms in the detailed description below (such terms have the meanings set out below unless the context requires otherwise):

Application—a game or other program for use on a mobile device

Browser—an application for viewing web based content on a user's mobile device, including but not limited to HTML, WAP or similar markup language pages on the Internet

Carrier—a provider of wireless phone services and network

Client recommender or client recommendation module—a component that is embedded in an application or into the mobile device to facilitate the recommendation of content

Content—assets such as applications (including games and other programs for mobile devices) images, movies, music ( for example ring tones) and other items purposed for mobile devices

Generation—a group of recommendation senders grouped by their proximity to the initiation of a series of recommendations

Java—Sun Microsystem's Java application language, however other versions of Java can also be used in other embodiments. By way of example, Java on a mobile device can be (but is not limited to) Java 2 Platform Micro-Edition (J2ME) and within the context of the Recommendation server Java can refer to (but is not limited to) Java Servlets.

Java Servlets—this API allows a software developer to add dynamic content to a web server using the Java platform. The generated content is commonly HTML, but may be other data such as XML. Servlets are the Java counterpart to dynamic web content technologies such as CGI or ASP.

JSR—Java Specification Request. Part of the community aspect of the development of Sun's Java language is the ability for the Java Community Process (JCP) to recommend enhancements to the base language which are adopted into future releases of the MIDP specification

JSR 75—A specification request which allows access to the file system of a mobile device from within a Java Midlet

Midlet—An application written in the J2ME programming language

MIDP—Mobile Information Device Profile, a specification put out by Sun Microsystems for the use of Java on embedded devices such as cell phones and PDAs. (Current versions are MIDP1 and MIDP2, however the present description is not limited to just these current versions).

Mobile Device—a cell phone or wireless device such as a PDA or e-mail appliance used in conjunction with a carrier network

MSISDN—the phone number of the mobile device

Portal or Storefront—an entity (carrier or non-carrier) that distributes content to users of mobile devices

Publisher—a developer and/or wholesaler of content or applications

Recipient user—a person receiving the recommendation from the Recommendation sender.

Recommendation Sender or Recommender User—a person initiating a recommendation

Recommendation Server or Recommender Server—a component made available via the Internet and that the client recommender module communicates with to initiate a recommendation.

Seed—to provide content or applications to a sub-set of the market in order to encourage viral distribution

URL—Uniform Resource Locator, the internet address of a specific page of information

WAP Headers—HTTP headers passed as part of a network connection between a mobile device browser and a server using HTTP (Hyper-Text Transfer Protocol)

Wireless Network—a wireless cell phone network operated by a Carrier and specifically the transmission of data and other digital information across said network

Wireless text message—A human readable message delivered via a wireless network to a mobile device. Example of this include email, SMS, WAP push and MMS messages.

WML—Wireless Markup Language, a meta-language used to specify the layout and content of pages viewable in a WAP Browser

Example embodiments described herein provides a system having the capability to leverage mobile carrier customers, who are active and voracious users of mobile data services, by having such active, mobile carrier customers recommend content and applications directly to other mobile carrier customers.

In accordance with at least one example embodiment, a recommender user or recommendation sender seeded with an enabled application (for example, a party who has purchased or been provided with an enabled application) can use the recommendation features of that application to recommend the purchase of the enabled application to their peers (recipient users of mobile devices).

In accordance with at least one further example embodiment, a member of a recommender group, while using an application on a mobile device, uses an element in the application user interface to send a recommendation to a recipient user. The recipient of the recommendation receives a personalized note on their mobile device advising them of the recommendation. The recipient is provided with an option to find out more and a URL where more information is available. If the option is selected, a selectable listing of all available acquisition options is presented. These options can include, for example, purchase pages for the application on a carrier storefront or from other store fronts or from the Internet, or could be a direct download link. When the recipient chooses the option that they want, their phone's browser is directed to the acquisition location that is associated with the option that they have selected, following which the recommended content may be immediately downloaded over the wireless network to the recipient's device (in the case where the selected option was a direct download link) or alternatively, the recipient could be presented with further instructions or options for acquiring the content.

Another embodiment of the system allows for the publisher or developer of the enabled application to present applications or content other than the one initially sent to the recipient of the recommendation.

In accordance with at least one example embodiment of the invention, an application publisher desiring to increase the purchase of his application provides a discounted or free of charge version of the application to a group of expert users (seeds the market) in the hopes that they will recommend the application to their peers. Such peers may also be provided the application at a discounted rate for the application that may vary in the hope that they too may recommend the application to further peers. For example, members of the seed group for the application may receive the application free of charge, the first group of people that they recommend to may pay 50% of the generally posted price for the application and all subsequent recipients may pay the full price.

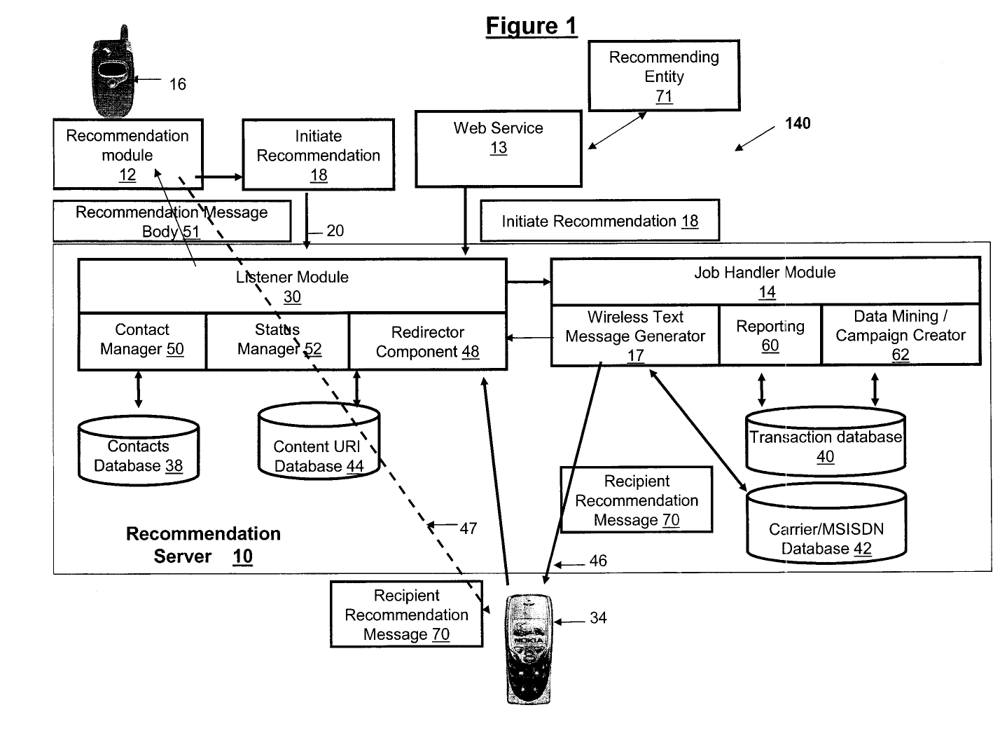

With reference to FIGS. 1-3, a recommendation and provisioning system according to example embodiments will now be discussed. Referring first to FIG. 1, the recommendation and provisioning system 140 according to at least one example embodiment relies on a client-server architecture, and includes a client-side recommendation module 12 and a server-side recommendation server 10.

### Description of Client Functionality

The client recommendation module 12 is, in an example embodiment, implemented by computer program instructions resident on mobile device 16 and executed by a processor of the device 16. The software for implementing the client recommendation module 12 may be embedded in an application transferred to a recommendation sender's mobile device 16 or resident on the device at the time that the recommendation sender acquires the device 16, such “recommend enabled” applications being provided, for example, by a publisher that desires to participate in the recommendation and provisioning system 140 described herein.

For example, in one embodiment, the entity that operates the recommendation server 10 can provide content publishers with a software tool kit that includes the software necessary for implementing the recommendation module 12. The publisher can then embed the software for implementing recommendation module 12 into an enabled application that is provided to the mobile device 16. In some embodiments, at least some of the software instructions for implementing recommendation module 12 may be resident on the device 16 separate from any specific recommend enabled application to be called on by such recommending applications as required. In such embodiments, a call or linking function is embedded in the recommending application.

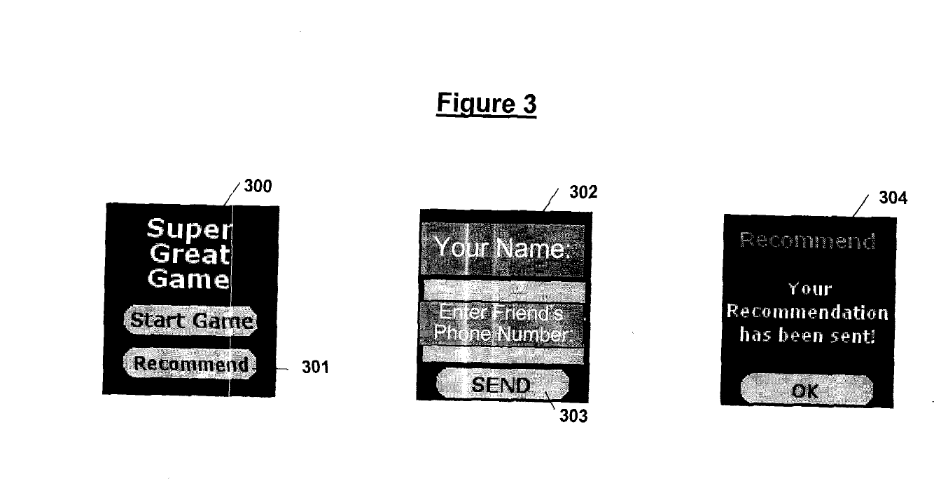

The recommendation module 12 generates on the mobile device 16 a user interface (see for example interface 300 of FIG. 3) that when selected, prompts the recommendation sender for the MSISDN of the recipient and the recommendation sender's name (to provide personalization in the message) (see for example interface 302 of FIG. 3). In some embodiments, the recommendation module 12 can permit the MSISDN for multiple recommendation recipients to be identified. Additionally, in at least one example embodiment, the MSISDN of the recommendation sender is also provided to the recommendation server 10. In the case of carriers that cannot or will not pass the recommender's MSISDN in the WAP headers, the recommendation sender will be prompted for their MSISDN the first time that they send a recommendation and this information will be stored on the mobile device 16 for future use.

In an alternate embodiment, the client recommender module 12 has available phonebook type functionality which opens a data connection to the contact manager 50 (in one example embodiment, contact manager 50 is resident on the recommendation server 10) and accesses a list of all recipients that the recommendation sender has recommended to from the contacts database 38 (also resident on the recommendation server 10). This enables the recommendation sender to select from a user interface presented on mobile device 16 multiple recipients from their peer group. In some embodiments, a user can add, delete and manage these contacts via a web portal.

In a further alternate embodiment, client recommendation module 12 uses MIDP2 and JSR 75 to provide access to the contacts list resident on the mobile device 16 without the use of the network.

An example of a potential user experience for the recommendation sender is illustrated in FIG. 3.

In particular, FIG. 3 shows three successive user interface screens, 300, 302, 304 generated on a display of mobile device 16. In user interface screen 300, the client recommender module 12 associated with the recommended application “Super great game” causes a “Recommend” button or prompt 301 to appear on the screen of the mobile device 16. Selection of the “Recommend” button 301 results in generation of user interface screen 302 which prompts the recommendation sender to enter their name and the MSISDN (or other suitable address) of the recommended recipient user. Selection of a “send” button 303 by the recommendation sender causes an initiation of a recommendation request message 18 (see FIG. 1) to be transmitted over a communications link 20 (which in an example embodiment will include the wireless network in which the mobile device 16 is active and the Internet) to the recommendation server 10 and specifically to a listener module 30 of the recommendation server 104. Among other things, in an example embodiment the initiate recommendation message 18 includes information identifying the content that is being recommended, the name of the recommendation sender, the address (ex. MSISDN) of the target recipient, and information identifying the recommendation sender's mobile device. The initiate recommendation message 18 may also include other information, including for example a status request flag or other indicator to indicate to the recommendation server 10 whether or not the mobile device 16 is to receive one or more status messages about the progress of the recommendation that is being sent to the recipient.

In example embodiments, once the mobile device 16 transmits the initiate recommendation message 18, a confirmation user interface screen 304 appears on the display screen of device 16.

As will be explained in greater detail below, once an initiate recommendation message is received and authenticated by the recommendation server 10, the recommendation server 10 will generate the body of a recommendation message for delivery to the target recipient mobile device 34. In various embodiments, the recommendation message can be delivered to the recipient's mobile device 34 in different ways. For example, in one embodiment the recommendation server 10 will generate a recipient recommendation message 70 and then send the recipient recommendation message 70 directly (over a communications link 46) to the recipient's mobile device 34.

In another example embodiment, a recipient recommendation message 70 generated by recommendation module 12 is delivered directly from the recommendation sender's device 16 over a communications link 47 to the recipient's device 34 using software support for the delivery of messages that is pre-installed on the recommendation sender's device 16. For example, the recipient recommendation message 70 may be sent in the same manner as a conventional wireless text message from mobile device 16 to mobile device 12 over the communications link 47, which may include the wireless communications network that the device 16 is located in, the wireless communications network that the device 34 is located in, and any intervening networks. In this embodiment the recommendation server 10 will, upon receiving and validating the recommendation details contained in the initiate recommendation message 18, provide an appropriate recommendation message body 51 to the client mobile device 16 over communications link 20, and the recommendation module 12 incorporates the recommendation message body 51 into recipient recommendation message 70 that will then be delivered by the client mobile device 16 to the recipient mobile device(s) 34 using the message delivery tools available on the device 16.

In at least some example embodiments, where more than one delivery option exists for delivering a recommendation message to a recipient's mobile device 34, the recommendation module 12 includes in the initiate recommendation message 18 an indication of which one of the delivery options should be used (for example, if (i) the recommendation server 10 should deliver the message; or (ii) the recommendation sender's device 16 should deliver the message). In various example embodiments, the recommendation sender may be prompted to select a delivery option, or the delivery option could be automatically selected by the recommendation module 12 (or at the recommendation server 10) based on predetermined criteria, including for example, what delivery options/resources are currently available, sender's preferences, recipient's preferences, and/or cost.

In at least some example embodiments, the client side functionality described above can alternatively be implemented through devices other than mobile device 16, for example as a Web Service, such that a recommendation request message can be received by the recommendation server 10 from a recommendation source other than mobile device 16. For example, the system 140 can include a Web Service 13 for receiving recommendation information from a recommending entity server 71, which may for example be operated by a carrier or other publisher. In an example embodiment, the recommending entity server 71 presents a website that allows a recommendation sender to recommend content. Through the website, a recommendation sender can enter an address (ex. MSISDN) identifying a target recipient for identified content. The recommendation sender can potentially access the web site of recommending entity 71 through a variety of means, including for example (but not limited to) a browser on a conventional laptop, or a browser on a mobile device (such as device 16). In addition to recommending specific content to third parties, a person could use the interface provided by recommending entity 71 to recommend content to their own mobile device by providing their own phone number—thus, a facility for self-recommendation is provided. The recommending entity 71 could also get information for target recipients from other sources, for example, from predetermined contact lists of users that have signed up in advance to receive content recommendations or otherwise been identified as parties to which recommendations should be sent.

The Web Service 13 acts as the interface between recommendation server 10 and the recommending entity 71, and in example embodiments re-formats messages from the recommending entity 71 into a format suitable for processing by the recommendation server, and re-formats messages from the recommendation server 10 into a format suitable for the recommending entity 71. For example, in one embodiment, the Web Service 13 receives a recommendation request, which will include among other things identification of the recommended content and identification of one or more target recipients, from the recommending entity 71. The Web Service 13 then packages that information into an initiate recommendation message 18 that is then passed on to the recommendation server 10. In an example embodiment, communications between the Web Service 13 and the recommending entity 71 are Simple Object Access Protocol (SOAP) compliant; however other suitable Web Service protocols could be used. In example embodiments, the Web service 13 can be implemented on a suitably configured server that is separate from the recommendation server 10, or alternatively, as a module on the recommendation server 10.

Accordingly, in example embodiments, the source of a recommendation request can be a recommendation sender's mobile device 16, or from another recommending entity 71.

### Description of Server Functionality

Referring again to FIG. 1, the Recommendation server 10 which is, in an example embodiment, a server or server cluster accessible via the Internet includes a Listener module 30 which provides the core API's for management of all incoming messages from the client recommender module 12. The recommendation server 10 also includes a contact manager module 50 (and associated contacts database 38), a status manager module 52, a redirector component module 48 (and associated content URI database 44), a job handler module 14, a wireless text message generator module 17, a reporting module 60, a data mining/campaign creator module 62, a transaction database 40 and a carrier/MSISDN database 42. In example embodiments the server modules identified above can be implemented by software executed by the processor or processors of one or more suitably configured servers, and the modules may be parts of a larger application, or may be stand alone applications, or combinations thereof.

The Listener Module 30 (which acts as the interface between the recommendation server 10 and the mobile device 16, and in some embodiments as an interface with Web Service 13) passes the initiate recommendation message 18 to the Job Handler Module 14 which creates a record in the transaction database 40. The Job Handler Module 14 also generates the body of a wireless text recipient recommendation message 70 that includes information that permits identification of the recommended content. As indicated above, in one example embodiment, a recommendation message 70 can be provided directly from the recommender's mobile device 16 to the recipient's mobile device 34—in such a configuration, the Job Handler Module 14 delivers the body 51 of the recipient recommendation message 70 back through the listener module 30 to the recommender's mobile device 16 to be ultimately delivered to the recipient's mobile device 34 (or to multiple recipient's mobile devices where multiple recipient MSISDNs have been identified).

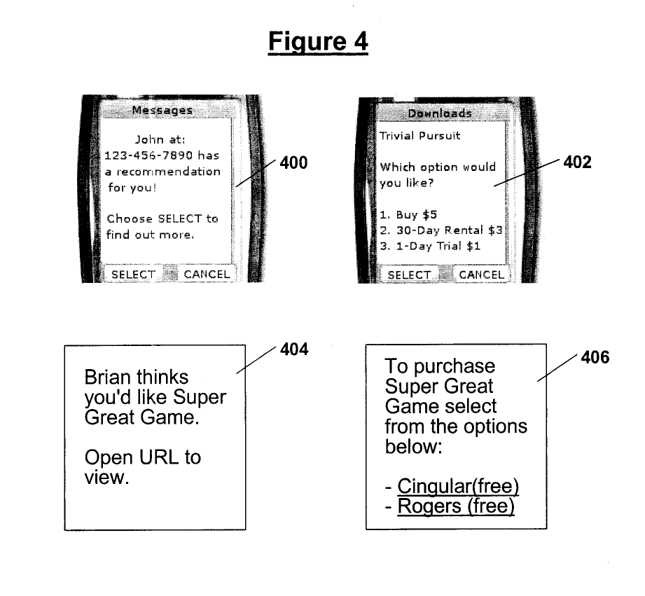

As indicated above, in an alternative embodiment, the recommendation message 70 is delivered by the recommendation server 10 to the recipient device 34 (or multiple recipient devices 34 where multiple recipient MSISDNs have been identified in the initiate recommendation message 18). In such case, the Job Handler Module 14 determines the wireless carrier of the recipient from the MSISDN/carrier database 42 and generates and delivers wireless text message 70 (which may for example be a WAP PUSH) through a communication link 46 including the appropriate wireless carrier's network to the recipient user's mobile device 34. User interface screen 400 on FIG. 4 illustrates the message received by the recipient. The Job Handler Module also delivers a wireless text message (which may for example be a WAP push) to the sender 16 of the recommendation to convey the current status of the recommendation. In some example embodiments, the recommendation sender can configure the recommendation module 12 to specify if they want to receive current status information about the recommendation or not, and if so, a status request is specified in the initiate recommendation message 18 sent by the recommendation sender's mobile device 16, prompting the recommendation server 10 to provide the current status message(s).

When the recipient user accepts and acts on the message, their mobile device 34 browser is directed to the redirector component 48 which determines the recipient's wireless carrier and phone capabilities, finds the location for the purchase or acquisition of the content or application that the recipient had been recommended from the Content URI database 44 and directs the recipient's mobile device browser to the appropriate location. In some example embodiments, there may be more than one suitable location from which the content or application can be purchased, in which case the list of locations is provided as link(s) by the redirector component 48 to the recipient's mobile device browser, so that a suitable link can then be selected by the recipient.

For reporting purposes, records are written to the transaction database 40 every time a recommendation is initiated or accepted. These records contain information on recommending and receiving user devices, carriers and the success or failure of the actions.

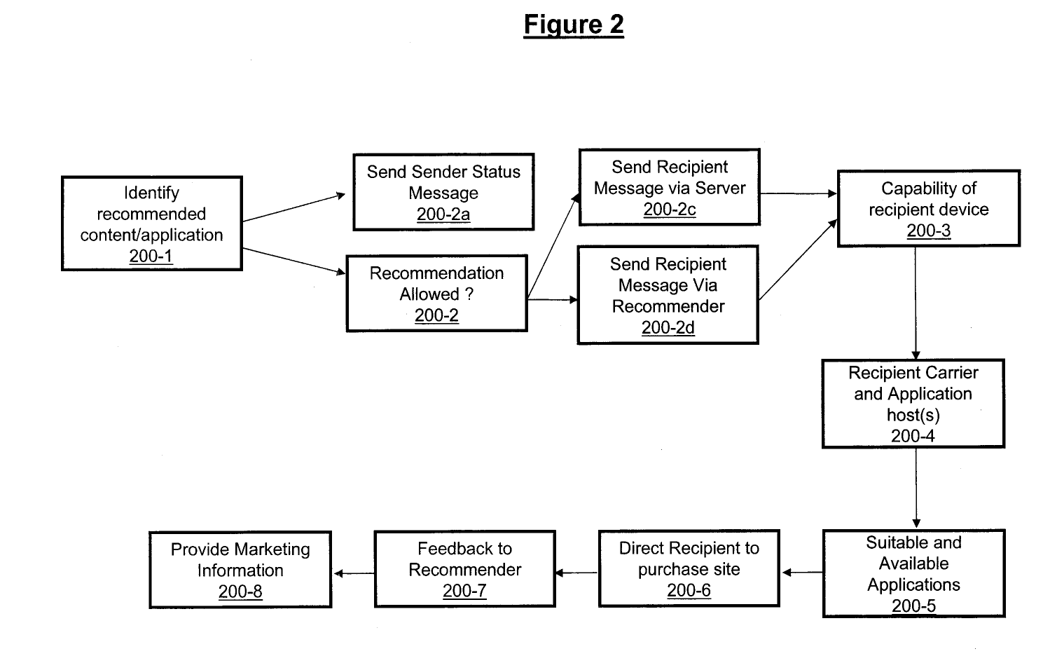

As is shown in FIG. 2, the following steps occur at the recommendation server 10 from recommendation initiation to completion:

1. Determine what the application or content is (uniquely determine what is being recommended) (Step 200-1)

2. Determine the mobile provider that the Recommendation Sender is subscribed to and determine if the recommendation is allowed (Step 200-2). Send a status message to the Recommendation sender (Step 200-2a).

3. Send the recommendation to the recipient user. In particular, if the server 10 is to deliver the message then determine the carrier of the recipient and deliver the wireless text message (Step 200-2c). Otherwise return the wireless text message body to the recommendation sender's mobile device 16 and the sender's mobile device 16 will deliver the message (Step 200-2d).

4. When the recipient acts upon the recommendation message have the recipient user's phone 34 go to a URL on the Recommendation server 10, and in particular, to the URL for the redirector module 48.

5. Determine the make, model and capabilities of the mobile device 34 owned by the Recipient (Step 200-3).

6. Determine the carrier that the Recipient is subscribed to and the list of allowable application hosts for that subscriber (Step 200-4)

7. Determine the set of versions of the specified application that can run on the recipient's device and are available on the application hosts that this recipient has access to (Step 200-5).

8. Direct the recipient to the acquisition site for the version that they have chosen (Step 200-6)

9. Provide feedback to the recommender about the state of the recommendation (Step 200-7).

10. Provide marketing information to the application publishers and mobile service
providers (Step 200-8).

Each of the above noted steps are described in detail below:

1. Determine what the content is (Step 200-1): Application content developers that wish to allow their content to be recommended must register with the operator of the recommendation system server 10 and will receive a set of development tools that allow them to add a ‘recommend’ feature, and in particular the software necessary to implement client recommendation module 12, to their recommending application. Each application/content is registered in the content URI database 44 and is given a unique identification based on the application name, publisher name and possibly other values (including for example the application version number). This identification is used by the system to uniquely identify an application or piece of content when a recommendation is made.

When a Mobile Device subscriber uses a recommended application and chooses to recommend a piece of content (be it the same application or another piece of content), the client recommend module 12 will contact recommendation server 10 over communications link 20, and inform it that there is a recommendation to be made from the recommendation sender to the recipient user specified for a piece of recommendable content with a pre-assigned ID code. Such information is included in the initiate recommendation message 18, sent from device 16 to Listener Module 30. The Recommendation Server 10 can then access information pertaining to that application via the unique ID code.

Alternatively, as indicated above, the initiate recommendation message 18 can be received via Web service 18 following a recommendation made through external entity 71.

2. Determine the Recommender Carrier and determine if the Recommendation is allowed (Steps 200-2 and 200-2a).

When the Recommendation is initiated from the application (and in particular the recommendation module 12), the data sent with the initiate recommendation message 18 over communication link 20 between the device and the Recommendation Server via the wireless network includes certain information in the WAP headers. This header field information can be coupled with the Recommender Users MSISDN and be used to determine the Carrier that the Recommender User is subscribed to.(For example, the header field (“via”) can contain information about the gateway owned by the carrier and be used to determine the mobile provider for the recommendation sender). In an example embodiment, this system is designed such that only subscribers of providers or carriers that have agreements with the operator of the Recommendation Server 10 can initiate recommendations, and if the carrier associated with a given recommendation is not registered with the Recommendation Server 10, then the recommendation will fail.

In example embodiments, after the recommendation server 10 looks up the recommendation sender's carrier, the server 10 will, at various stages through the recommendation and acceptance process, deliver one or more status messages back to the recommendation sender advising the sender of the status of the sender's recommendation. Potential status messages are, for example: failed—for recommendations that cannot be delivered; pending—for recommendations which are delivered but have not yet been acted on; and accepted—for recommendations which have been delivered and acted on. Additional details pertaining to the reasons for failures are also made available to the sender—for example if the carrier for the recommendation sender is not registered with the recommendation server 10, the recommendation will fail and the status message will indicate the reason for the failure.

3. Deliver the message (Step 200-2c or 200-2d)

In one example embodiment, the Recommendation Server 10 generates a unique URL for the recommendation and will then generate the text of a wireless text recipient recommendation message 70 that includes the URL and details about the recommendation. The URL includes a link back to the redirector component 48 of the recommendation server 10. The Recommendation Server 10 or the client device 16 will then send a wireless text recommendation message 70 to the mobile device 34 of the recipient (or mobile device 34 where a plurality of recipient devices have been identified) informing them of the recommendation (see FIG. 4, user interface 400, or alternatively, FIG. 4, user interface 404). In an example embodiment, the recommendation is sent over a communication link 46 that includes both the Internet and a wireless network (see FIG. 1) (wireless network may be the same network in which recommender device 16 is situated, or it could be a different network). In some embodiments, the Recommendation Server 10 may be connected to the wireless network 46 without an intermediate connection through the Internet. In an example embodiment, the recommendation server 10 may send the recommendation message 70 as an SMS or WAP push to the mobile device(s) 34 of the recipient(s) informing them of the recommendation.

As noted above, the recipient recommendation message 70 can, in some example embodiments, alternatively be sent from the recommendation sender's mobile device 16 after the recommendation server 10 sends the recommendation message body 51 to the sender's mobile device 16.

4 and 5. Determine the make, model and capabilities of the Recipient Mobile Device (Step 200-3)

Example alternative interface screens 400 and 404 each identify the recommender and prompts the recipient through a select button (screen 400) or a selectable URL (“Open URL to view”) (screen 404) to request further information. If the Recipient chooses to accept the recommendation the recipient's Mobile Device 34 will connect (using the URL that was included in the recommendation message 70) via the mobile network 46 to the Recommendation Server 10. The communications between the recipient's Mobile Device 34 and the Recommendation Server 10 includes WAP header information with information about the Mobile Device 34. This information can be used to determine the make and model of the recipient's device 34. For example, one of the headers (user-agent) may contain the make and model of the mobile device 34 and another (x-wap-profile) may contain a URL to a document containing detailed capability information of the mobile device 34.

6. Determine the Carrier that the Recipient is subscribed to (Step 200-4)

As in step 200-1, the WAP Header information and recipients MSISDN information exchanged during the network connection provides the Recommendation Server 10 with enough information to determine the recipient's Carrier (for example, the name of the gateway used by the Carrier (the “via” header). Once the Carrier is known, the decision to allow or disallow the recommendation can be made based upon the availability of appropriate content and/or the existence of a business agreement between the Carrier and the operator of the Recommendation Server 10. If the recommendation is not allowed, the Recommender will be informed of the failure via the status messages sent to him as described above. All of the existing business rules that a Carrier has with regards to access to content will remain intact. Once the recipient's Carrier is known, the Recommendation Server 10 determines the set of available storefronts to use and also determines the set of application versions available to the recipient. This may be a single application version on a single storefront or multiple versions on multiple storefronts. Business logic could also be applied in cases of multiple versions/storefronts to simplify the experience for a Recipient user.

7. Determine the set of versions of the specified application that can run on the Recipient's Mobile Device and are available on the storefronts that this Recipient has access to(step 200-5)

Each storefront that the Recommendation Server 10 is aware of provides a list of the applications available including the following information:

ID of the content (as given in step 200-1)

Mobile Devices that this version of the content is available for (could be for multiple or all devices or a single device)

A means of directing a mobile device to an appropriate acquisition location for a given content version on a given host. This location is host dependent and is used as a hint by the system. This, coupled with knowledge of how that host is configured, will redirect the recipient's mobile phone browser to the appropriate location. For example, it may be a product id that is appended to a host specific URL to build the final purchase URL.

Each content item (including applications and other items) can have multiple versions available as content is often slightly modified to support the capabilities of specific mobile devices (colour support, number of soft keys, screen size, type of ringtones, etc.). The system (recommendation server 10) will look at the list of content versions available that support the device that the recipient was using when the recipient accepted the recommendation. This is done for each storefront available to the recipient user. By matching this data, the redirector module 48 determines the set of versions to offer the recipient user and the links to the purchase page for each version.

8. Direct the recipient to the storefront for the version that they have chosen (step 200-6)

As indicated on the user interface 402, the list of available versions is then presented to the recipient via their Mobile Device browser where each version is a link to a purchase page as determined in step 200-5. Examples of user interfaces for presenting the options to a recipient user include, but are not limited to, the user interface screens 402 and 406 shown in FIG. 4, where screen 402 shows different license options (licence periods in the illustrated example) and screen 406 shows different store fronts form which the content can be obtained. The recipient can then choose any one of these versions and the recipient mobile device 34 will be automatically linked to the correct location or site for the final acquisition and download to take place. In one example embodiment, when a recipient selects a licence option, information about the selected link is sent back to the redirector component 48 which then redirects the browser on the device 34 to the URL for the selected storefront.

9. Provide feedback to the sender about the state of the recommendation

After the recommendation is initiated, the Recommendation sender may be sent a wireless text message (for example, a WAP push message) that includes a link to a page maintained by the status manager 52 of recommendation server 10 that provides status of the specific recommendation. Included in the status is the time of the recommendation, the application information and, for each recipient, a current status (pending, accepted, error, etc). (see for example interface screen 304 in FIG. 3) At each step of the recommendation process, the system (and in particular the status manager 50) tracks the actions taken.

10. Provide marketing information to the application publishers and mobile service providers

Application publishers, Carriers and Portals can access reports detailing the recommendation history for users and content applicable to them via a web site portal supported by the system. These reports allow them to see trends, determine popular applications, most active recommenders and other marketing information. The capability also exists to provide a raw data dump of all the recommendation history pertinent to them for inclusion in their own internal data tracking and reporting systems.

From this data, application publishers and wireless carriers can seed the market with new applications or pieces of content in order to encourage their rapid adoption and an increased revenue stream.

In at least one example embodiment of the invention, a wireless text message (for example a WAP push) is sent to the members of the seed group encouraging them to get the application or content. When the message recipient selects the link, the same process is followed as if they had received a recommendation. In this scenario, the content or application would typically be provided to the Recipient at no-cost, or a considerably reduced cost.

In at least one example, among other things the recommendation server 10 tracks when a recommendation message 70 is sent to a target mobile device 34; tracks when a target mobile device 34 accepts a recommendation by selecting a link (for example in interfaces 400 or 404) back to the recommendation server; and tracks when a recommendation recipient indicates a desire to purchase the recommended content (for example, by selecting an option such as in interface 402 or 406). In example embodiments, the publisher (or carrier) is charged an agreed upon rate each time one or more of the above events occurred, and the rate may escalate with each additional step closer that the recipient user gets to actually acquiring the content.

Therefore, what is disclosed is a peer to peer recommendation system that allows users of a particular application or content to easily recommend the application or content to their peer group from their Wireless Device to another Wireless Device. Example embodiments of the system disclosed herein applies the appropriate routing and business logic to provide the appropriate content to the appropriate device at the correct price point depending on a pre-defined set of business rules and using existing Carrier or Portal infrastructure.

Variations exist for the initiation of a recommendation network but the subsequent recommending and direction to appropriate content remains constant.

While the invention has been described according to what are presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention. Therefore, the invention must be accorded the broadest possible interpretation so as to encompass all such modifications and equivalent structures and functions.

1. A recommendation system for mobile device content comprising: a recommendation server enabled to communicate with a wireless mobile device of a recipient user, the server being configured for receiving from a recommendation source a recommendation request message including information identifying recommended content and a recipient user, determining based on predetermined criteria if a recommendation is permitted and if so, causing a recipient recommendation message including information identifying the recommended content to be sent to the recipient user's mobile device.

2. The system of claim 1 wherein the recommendation source comprises a mobile device of a recommendation sender and the recommendation server is configured for determining a carrier for the recommendation sender's mobile device in dependence on information sent with the recommendation request message, and the predetermined criteria includes a requirement that the carrier for the recommendation sender's mobile device be registered with the recommendation server otherwise the recommendation will not be permitted.

3. The system of claim 2 wherein the recommendation server is configured for, after receiving the recommendation request message, sending a status message to the recommendation sender's mobile device to advise the recommendation sender of a recommendation status.

4. The system of claim 1 wherein the recommendation server is configured to cause the recipient recommendation message to include address information for directing a browser on the recipient user's mobile device to connect the recipient user's mobile device to the recommendation server.

5. The system of claim 4 wherein the recommendation server is configured to send the recipient recommendation message from the recommendation server as a text message addressed to the recipient user's mobile device.

6. The system of claim 4 wherein the recommendation source comprises a mobile device of a recommendation sender and the recommendation server is configured to generate a text message body for the recipient recommendation message and send the text message body to the recommendation sender's mobile device, thereby causing the recommendation sender's mobile device to send the recipient recommendation message to the recipient user's mobile device.

7. The system of claim 1 wherein the recommendation server is configured to, after connection of the recipient user's mobile device thereto, direct the recipient user's mobile device to a site from which the recommended content can be obtained.

8. The system of claim 7 wherein the recommendation server is configured for, prior to directing the recipient's user's mobile device to the site from which the recommended content can be obtained, determining based on information received from the recipient user's mobile device versions of the recommended content that are available for the recipient user's mobile device, and presenting for display on the recipient user's mobile device a list of the available versions.

9. The system of claim 7 wherein the recommendation server is configured for, prior to directing the recipient's user's mobile device to the site from which the recommended content can be obtained, determining based on information received from the recipient user's mobile device a plurality of possible sites from which the recommended content is available for the recipient user's mobile device, presenting for display on the recipient user's mobile device information identifying the possible sites, and receiving from the recipient user's mobile device information identifying a user selection of one of the plurality of possible sites.

10. The system, as claimed in claim 1 wherein the recommendation server is configured to cause the recipient recommendation message to include information for identifying a party that initiated the recommendation request message to the recipient user.

11. The system of claim 1 further comprising a recommendation sender's mobile device, the recommendation sender's mobile device having a recommendation module for generating on a user interface thereof a prompt enticing the recommendation sender to initiate a recommendation and for sending the recommendation request message to the recommendation server.

12. The system of claim 1 wherein the recommendation source comprises a remote recommending entity server, the system including an Web Service for receiving a recommendation request from the remote recommending entity service and generating the recommendation request message for the recommendation server in dependence on the received recommendation request.

13. The system of claim 1 wherein the recommendation request message includes information identifying a plurality of recipient users, and the recommendation server is configured for causing the recipient recommendation message to be sent to the plurality of recipient users.

14. A method for facilitating recommendation of content from a recommendation sender to a mobile device of a recipient user, comprising the following steps:
(a) receiving at a recommendation server a recommendation request message requesting that selected content be recommended to a recipient mobile device that is identified in the recommendation request message;
(b) causing a recipient recommendation message to be sent to the recipient mobile device that includes address information for directing a browser on the recipient mobile device to the recommendation server;
(c) receiving at the recommendation server from the recipient mobile device information about the recipient mobile device and in dependence thereon identifying at least one host location that the recipient user can access to obtain the selected content;
(d) receiving an acceptance from the recipient device indicating that the recipient user desires to obtain the selected content and directing the recipient mobile device to a host location to obtain the selected content.

15. The method of claim 14 wherein the recommendation request message is received from a recommendation sender's mobile device, the method comprising, after step (a) and prior to step (b), the steps of:
identifying a mobile device carrier that the recommendation sender's mobile device is subscribed to; and
verifying if a recommendation is allowed based on the identity of the mobile device carrier.

16. The method of claim 14 further comprising after step (c) and before step (d):
identifying a set of versions of the selected content that is suitable for the recipient mobile device and that is available on the hosts that the recipient has access to; and
providing for display on the recipient mobile device a selectable listing of available versions of the selected content.

17. The method of claim 14 wherein step (b) comprises sending the recipient recommendation message from the recommendation server as a text message addressed to the recipient mobile device.

18. The method of claim 15 wherein step (b) comprises generating a text message body for the recipient recommendation message at the recommendation server and sending the text message body to the recommendation sender's mobile device, thereby causing the recommendation sender's mobile device to send the recipient recommendation message to the recipient mobile device.

19. The method of claim 14 comprising a further step of providing feedback to a source of the recommendation request message as to whether the recipient mobile device has been directed to the host location.

20. The method of claim 14 wherein the recipient recommendation message is received through a Web service from a recommending entity.

21. The method of claim 14 wherein the recommendation request includes information identifying a plurality of recipient mobile devices for recommending the content to, and step (b) includes causing the recipient recommendation message to be sent to at least some of the plurality of recipient mobile devices.

22. A computer program product for facilitating recommendation of content from a mobile device of a recommendation sender to a mobile device of a recipient user, comprising a computer readable medium carrying computer instructions executable by a server for carrying out the method of claim 14.
